(19) United States
(12) Patent Application Publication
(10) Pub. No.: US 2008/0136059 A1
(43) Pub. Date: Jun. 12, 2008

(54) Balloon catheter, its fabrication method, and method for fixedly mounting a balloon on catheter tube

(75) Inventors: Yosuke Yoshino, Kawagoe (JP); Masanori Kimura, Sowa (JP); Takashi Takezawa, Sowa (JP)

Correspondence Address: RADER FISHMAN & GRAUER PLLC, LION BUILDING, 1233 20TH STREET N.W., SUITE 501, WASHINGTON, DC, 20036, US

(73) Assignee: Bi-SMEDIX INC., Mita-shi (JP)

(21) Appl. No.: 11/984,716

(22) Filed: Nov. 21, 2007

Related U.S. Application Data
(63) Continuation of application No. 09/979,045, filed on May 28, 2002, now abandoned.

(30) Foreign Application Priority Data
May 16, 1999 (JP) 11-171473
May 15, 2000 (JP) 2000-180528

(51) Int. Cl. B29C 41/14

(52) U.S. Cl. 264/299

(57) ABSTRACT

To provide a balloon catheter having a flexible and highly expandable balloon so as to prevent the inner wall of the blood vessel from being damaged by the passage of the balloon In a balloon catheter aimed to be stayed in a blood vessel and to be used mainly for the occlusion of a blood vessel, the balloon comprises a material selected from materials which have sufficient flexibility for preventing a blood vessel blocking operation from giving a damage to a vascular wall, have sufficient elasticity with its shrink characteristics when removing the catheter, and prevent a thrombus due to a direct contact to blood; and a maximum stretching of the material of said balloon in the state stayed in the blood vessel is defined so as to exceed a maximum stretching of said balloon itself.

This is a continuation of application Ser. No. 09/979,045, filed on May 28, 2002, which is a 371 application of PCT/JP00/03141 filed on May 16, 2000, the entire contents being incorporated by reference. The present application claims priority based on Japanese Patent Application No. 11-171473, filed May 16, 1999 and Japanese Patent Application No. 2000-180528, filed May 15, 2000, the entirety of which being incorporated herein by reference.

### TECHNICAL FIELD

The present invention relates to a balloon catheter and its fabrication method. The balloon catheter intended in the present invention is such a medical instrument that is inserted into the blood vessel and made to stay there, and blocks the vascular stream by expanding the balloon.

### BACKGROUND ART

Recently, a medical treatment technique for keeping a long-term cyclic operation for injecting, aspirating and recovering intense anti-cancer drugs has been put into practice and innovative results are achieved in the actual medical field, in which the arterial flow to the diseased parts of the internal organs and the venous flow from those parts and organs are blocked by using the balloon catheter, the arterial flow and the venous flow for the predetermined organ is blocked out from the whole-body cardiovascular system, and the anti-cancer drugs in high concentration are injected at the arterial blood vessel into the predetermined organ with its diseased parts being isolated as well as the anti-cancer drugs flowing out from the venous blood vessel (or the portal vein) are exteriorized. In general, this is called an anti-cancer drug perfusion system, which allows the highly concentrated anti-cancer drugs to be exposed to the cancer part and enables a systematic operation for injecting and aspirating the anti-cancer drugs because the anti-cancer drugs may not circulate in the whole body through the heart.

Because it is, however, required to insert and stay the catheter, for example, directly from the femoral artery to the arterial part of the diseased part of the internal organ, there may be the possibility where the balloon part of the catheter may damage the arterial vascular wall in the system during the inserting operation in a case where the balloon part itself is hard when non-expanded. In general, it is well known that the internal arterial vascular wall is more vulnerable than the internal venous vascular wall is. The larger the diameter of the catheter tube, the more the risk of damaging to the inner vascular wall. In the conventional balloon catheter, the balloon in its non-expanded state is made very “solid” in order to establish mainly an accurate sealing ability when the balloon expands, which may frequently result in damages in the inner vascular wall by the balloon part during the process for inserting the catheter to the arterial blood vessel at the diseased part. In addition, as for silicon and polyurethane synthetic rubbers used conventionally, their restoring force is so weak after expansion work that any damage may occur in the blood vessel when removing the catheter. Latex materials cannot provide larger expansion coefficients, and, moreover, may cause the occurrence of thrombus due to their direct contact to the blood itself. This thrombus may arise when the inner vascular wall is damaged.

### BRIEF DESCRIPTION OF THE DRAWINGS

FIG. 1 is a schematic diagram of the first embodiment of the fabrication apparatus for the balloon of the balloon catheter according to the present invention.

FIG. 2 is a partial side view of the balloon formation part of the mold used in the apparatus shown in FIG. 1.

FIG. 3 is a schematic diagram of the second embodiment of the fabrication apparatus for the balloon of the balloon catheter according to the present invention.

FIG. 4 illustrates that the balloon catheter according to the present invention is inserted into the hepatic artery, and that the balloon is expanded for blocking the vascular stream.

FIG. 5 is a schematic diagram of the balloon protection tube used with the balloon catheter of the present invention in association with the sheath and the balloon catheter.

FIG. 6 is a front view of the insertion hole of the sheath in which the balloon catheter of the present invention is inserted.

FIGS. 7A to 7D show illustrative models of macro-molecular structures expanded by the injection molding process, the extrusion molding process, the melting molding process with mold tools and the dip toning process with liquid solutions, respectively, used to better understand the present invention.

FIG. 8 shows an embodiment for obtaining the balloon with highly expandable diameter of the present invention.

FIGS. 9A and 9B show the conventional mount method of the balloon and the mount method applying the principles of the present invention, respectively.

FIG. 10 shows a table of elongation percentage of SEES bulk balloon according to the principles of the present invention.

FIG. 11 shows an illustrative model for providing a theoretical understanding of the principles of the present invention.

FIG. 12 shows a table of measured values for the principles of the present invention to be applicable to the materials other than SEBS materials.

FIG. 13 shows an embodiment facilitating the mounting of the bulk balloon at the catheter.

### DISCLOSURE OF THE INVENTION

The present invention provides a balloon catheter preferably used for anti-cancer drug perfusion systems, which is composed of materials that will not damage the inner vascular wall with its balloon part being in the occlusion state when the catheter is inserted and fixed at a predetermined position in the blood vessel, and that provide a reliable occlusion ability when expanded.

The present invention provides a larger occlusion volume even when a balloon is mounted on a catheter tube with a smaller diameter. According to the present invention, a fabrication method for a balloon catheter as described above is also provided.

A balloon catheter is inserted in the blood vessel and has a balloon for blocking the vascular stream in the blood vessel when expanded. Materials used for the balloon are flexible especially when occluding the blood vessel and being extracted for itself, and selected from styrene group SIS, SBS, SEBS, SEPS thermoplastic elastomer materials. In a preferred embodiment, the tensile rupture ductility is between 800% and 1000%, and the used material is selected from materials that do not make thrombus when contacting to the blood.

As for the elastomer materials applied to the balloon materials used for the balloon catheter, latex or silicon resin in rubber materials, or polyolefin, polyester, polyurethane, polyamide, or styrene compounds etc. in plastic materials is typically used. As for the materials used for flexible balloons for occluding a blood vessel, elastic latex, silicon resin or polyurethane resin is generally used.

Those balloon materials have their own mechanical characteristics with respect to the maximum elongation percentage (tensile rupture ductility), which include the following typical balloon materials; the range of ductility of SB group is approximately from 300% to 1000%, the range of ductility of SEBS group is approximately from 500% to 1000%, the range of ductility of natural rubber is approximately from 300% to 900%, the range of ductility of silicon rubber is approximately from 230% to 900%, the range of ductility of olefin group is approximately from 300% to 600%, the range of ductility of vinyl chloride group is approximately from 400% to 500%, the range of ductility of polyurethane group is approximately from 300% to 800%, the range of ductility of polyester group is approximately from 380% to 420%, and the range of ductility of polyamide group is approximately from 200% to 400%. The upper bound for the ductility of general flexible materials is approximately 100%.

The expansion characteristics of typical elastic balloon materials such as latex, SEBS, silicon rubber, etc. are described as examples below, in which the reference balloon is formed with its inner diameter of the balloon being 6 mm and its wall thickness being 0.5 mm.

Water was filled into the balloon to expand it. The balloon made of latex was broken at the full limits of 700% elongation and 75 m1 injection water volume, the balloon made of SEBS was broken at the full limits of approximately 830% elongation and approximately 130 m1 injection water volume, and the balloon made of silicon was broken at the full limits of 700% elongation and approximately 120 m1 injection water volume. As apparent from those experimental evidences, the full limits of the elongation of the balloon are almost identical to those for the individual raw materials.

The above fact explains that, if applying the balloon made of the existing balloon materials simply to the catheter, the maximum elongation characteristics is bound by the intrinsic elongation characteristics of the existing materials.

The present invention provides a highly flexible, highly elastic and highly extendable diameter balloon catheter. The balloon is expected to have higher flexibility in order to prevent the non-expanded balloon from damaging the blood vessel during the balloon moving operation when positioning and fixing the balloon mounted on the catheter tube at the predetermined position in the blood vessel. After completing the medical treatment, it is required to release the expansion operation for the balloon and draw out the catheter from the blood vessel in the human body. At this time, the balloon is expected to be returned to the non-expanded state or substantially original state. Therefore, it is desirable that the balloon itself is highly elastic. In addition, the diameter of the catheter is required to be smaller enough compared with the inner diameter of the inner wall of the blood vessel so that the catheter may move easily in the blood vessel. Therefore, the balloon mounted on such a catheter with small diameter must have higher expandability and it must block the vascular stream absolutely when expanded. For the additional condition, the materials used for the balloon should not be those causing the blood contacting to them to arise any thrombi. Thrombus may occur due to the damage of the inner vascular wall by the balloon.

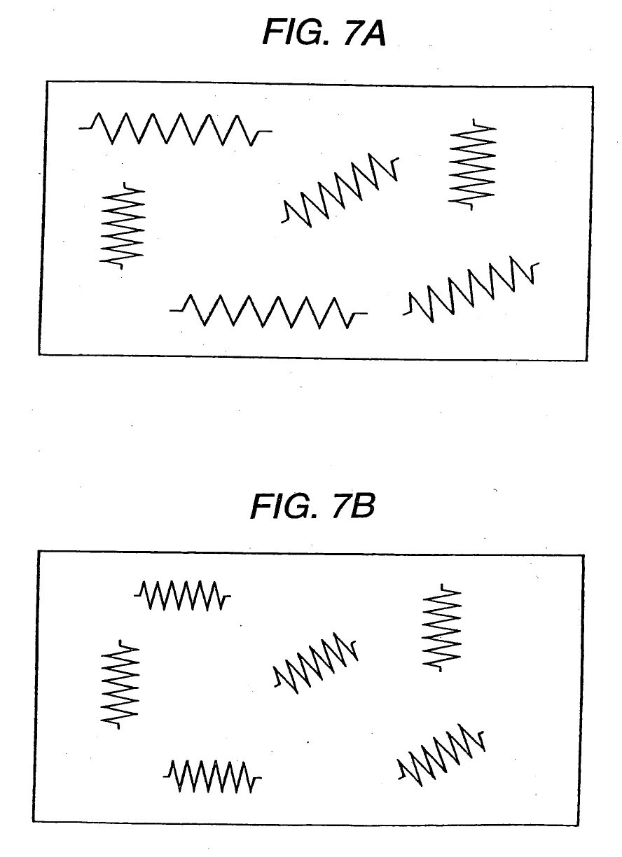

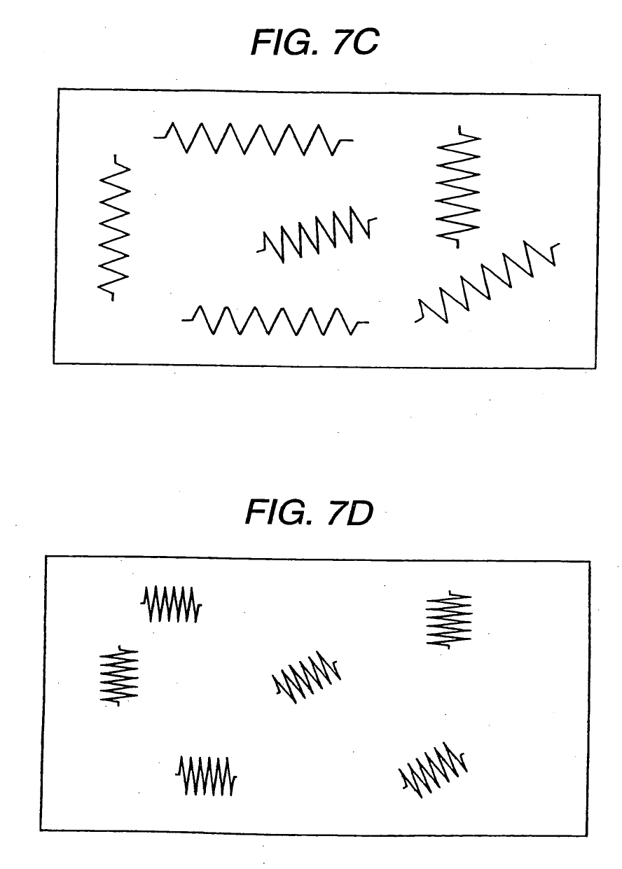

A balloon is formed generally by using a physical process including melting, molding and cooling for thermoplastic materials. FIGS. 7A, 7B, 7C and 7D illustrate models of macro-molecular elongation for the extrusion molding, the melting molding with a mold, the injection molding and the dip molding by the liquid solution, respectively. The graphical symbols in the figure schematically represent the elongation percentage of the macro-molecular chain as a visual image of the cross section of the coil.

As the molten material flows through the cavity into the mold in the balloon fabricated by the injection molding shown in FIG. 7C, a deviation in the macro-molecular chain arises along the injection flow, and the elongation characteristic greatly depends upon the direction. As shown in this figure, the coils arranged in the individual directions show their own elongation states, and the degree of elongation in those directions is restrained.

FIG. 7A shows a case of the extrusion molding. As the molding material flows with its orientation in the direction of the extrusion work and is solidified, the molecular chain extends in the longitudinal direction. Owing to this characteristic in the molding work, the elongation percentage of the coil in the longitudinal direction is restrained.

In the case shown in FIG. 7B, as the molten material is shaped in the mold, its molecular structure is wholly uniform, and directional dependency does not occur in general, and thus, uniform elongation characteristics can be obtained.

In the dip forming using the liquid solution shown in FIG.in, as the polymer is solved in the solvent, and the polymer is coated on the surface of the mold, and then, the solvent is removed, more uniform elongation characteristics can be obtained.

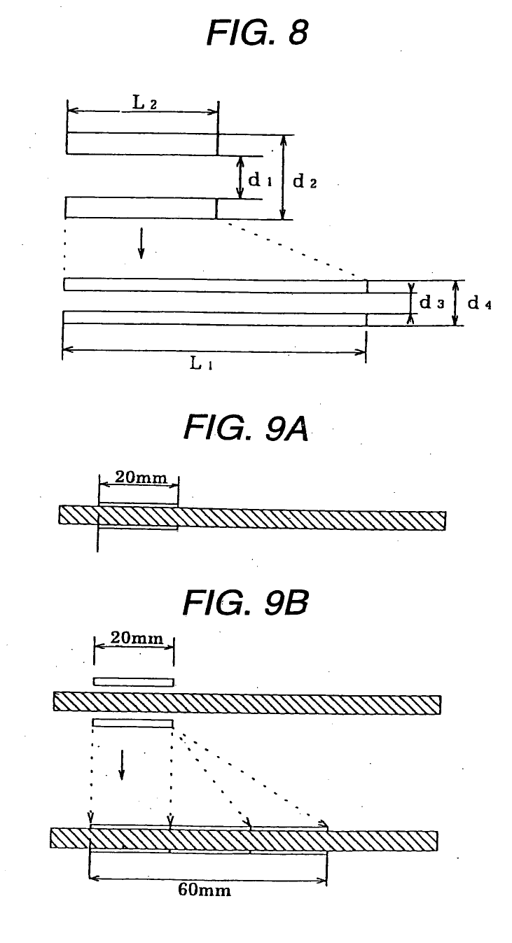

FIG. 8 shows an embodiment for obtaining a balloon having large expandable diameter according to the present invention. In this embodiment, as described in detail below, the balloon is mounted on the catheter designed to have a size equal to the desired tube outer diameter, with the balloon being elongated in the longitudinal direction. In this mounting operation, the structure of the catheter balloon in the product is determined at first, and then, the stretch ratio at the fixing of the balloon is determined. Suppose that L2 is the length of the balloon before stretching, L1 is the length of the balloon before stretching, d1 is the inner diameter of the balloon before stretching, d2 is the outer diameter of the balloon before stretching, d3 is the inner diameter of the balloon after stretching and that d4 is the outer diameter of the balloon after stretching, the elongation ratio ε is defined by L2/L1, the inner diameter d1 of the balloon before stretching can be represented by the product of the square root of the reciprocal of the elongation ratio ε and the inner diameter d3 of the balloon after stretching, and the outer diameter d2 of the balloon before stretching can be represented by the product of the square root of the reciprocal of the elongation ratio ε and the outer diameter d4 of the balloon after stretching. These relationships provide design formulae for the bulk balloon (balloon formed after stretching). This is effective for the design of balloons because it is necessary to consider the size of the catheter the outer diameter of the catheter tube at first.

FIG. 9A illustrates an ordinary mounting method in which the balloon is mounted onto the catheter tube without stretching. This is an embodiment in which SEBS balloon with 2.8 mm balloon otter diameter, 2 mm balloon inner diameter, and 0.4 mm thickness and 20 mm length is mounted on 6 French catheter tube (2 mm outer diameter). FIG. 9B is an mounting example of the balloon in which the elongation multiplying factor is 200%, that is, the balloon composed of the same material and structure as in FIG. 9A is stretched to the length L1=60 mm, which is equal to twice as long as the original length of the balloon, excluding the original length of the balloon itself. In the design of those bulk balloons, it is necessary to determine the outer diameter of the catheter tube to be mounted with the balloon at first. This value for the outer diameter can be substantially equal to the internal diameter d3 after balloon stretching. Next, the balloon fixing length is determined. In this example, the fixing length L2 is 20 mm. Thus, the elongation ratio ε=L2/L1 is ⅓. In this example, the calculation value of the inner diameter d1 of the balloon before stretching is estimated to be 3.46 mm by applying the above design formula. The outer diameter of the balloon before stretching is estimated to be 4.85 mm by assuming that the thickness of the balloon after stretching is 0.4 mm, which 25 is equal to the thickness before stretching, and its outer diameter is 2.8 mm.

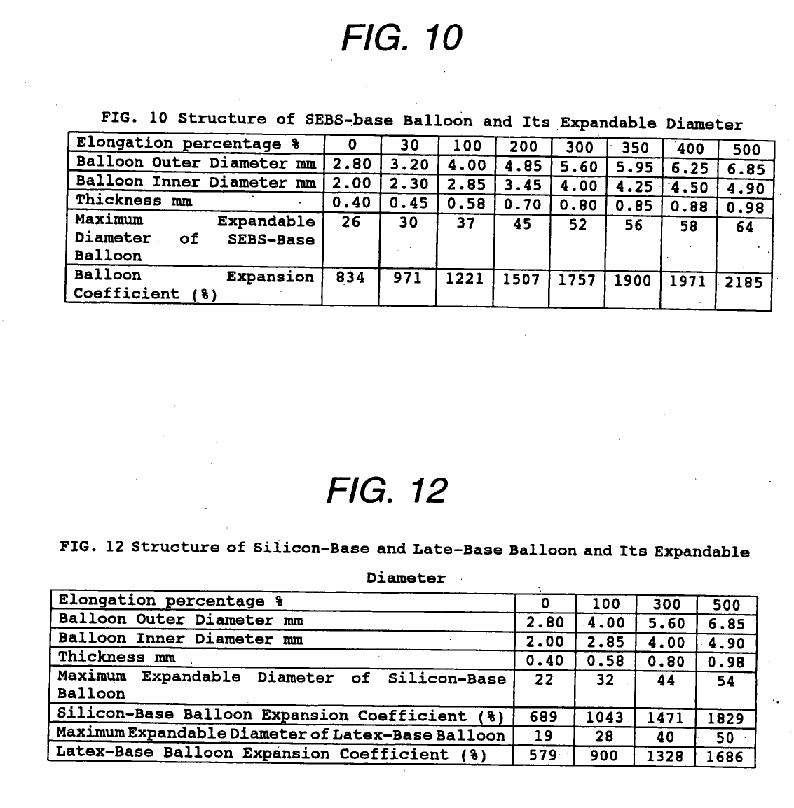

FIG. 10 shows a table including the measured values for the maximum diameter (mm) and the apparent stretching degree (%) of the balloon mounted on the catheter tube (6 French) shown in the above example, with the SEBS bulk balloon being fixed at the following elongation percentages: 0% (for the non-stretched length, 20 mm), 30% (stretched to 26 mm), 100% (stretched to 40 mm), 200% (stretched to 60 mm), 300% (stretched to 80 mm), 350% (stretched to 90 mm), 400% (stretched to 100 mm), and 500% (stretched to 120 mm). As apparent from these measurement results, in a case where the bulk balloon is mounted in its elongated state according to the present invention, its elongation percentage highly exceeds in appearance the maximum elongation percentage (at most 1000%) specific to the materials without stretching. Thus, the highly expandable diameter characteristics of the balloon, which cannot be provided by the conventional balloon can be obtained.

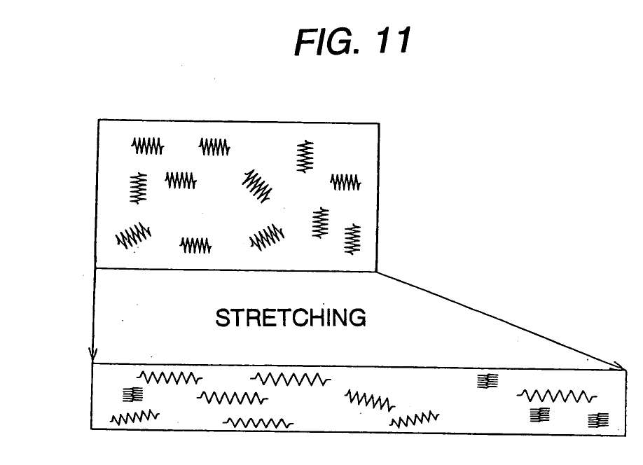

FIG. 11 illustrates a theoretical understanding of the highly expandable diameter characteristics in the balloon of the present invention. The upper part of FIG. 11 is a schematic diagram of the macro-molecular chain structure in the bulk balloon before stretching, in which the graphical chain symbol represents a tension spring as a model of the macro-molecular cross-section. Though the macro-molecular chain in the longitudinal direction is stretched as shown in the lower part in FIG. 11, the macro-molecular chain in the radial direction is not stretched, and thus, it is supposed that the expandability characteristics in the radial direction of the bulk balloon may be maintained after stretching. Therefore, by making the diameter of the bulk balloon larger than the diameter of the catheter tube on which the bulk balloon is mounted, and fixing the bulk balloon with its longitudinal length stretched, the diameter of the bulk balloon can be expanded up to its original expandable diameter.

Though the above example refers to SEBS balloon material, the present invention can be applied to other materials. FIG. 12 shows the measured values for the expandability characteristic for the elongation percentages, 0%, 100%, 300% and 500% in the balloons made of silicon resin and latex. As is apparent from those measured values, by applying the stretching processing according to the present invention to the balloon materials used conventionally, expandability far greater than the maximum expandability materials themselves can be provided.

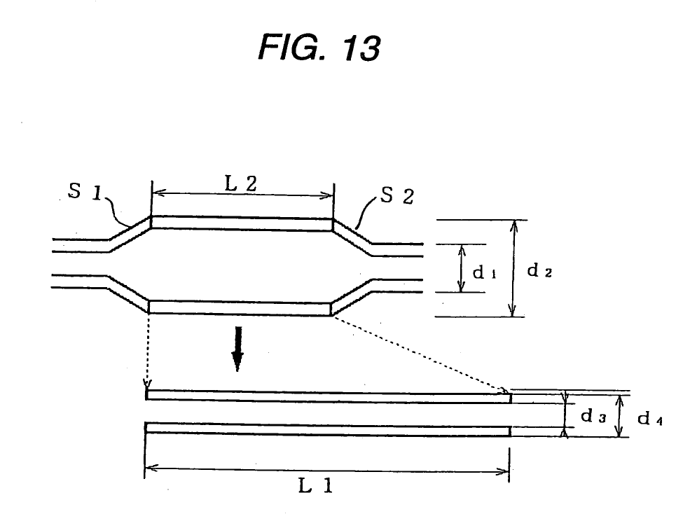

FIG. 13 illustrates an example of a bulk balloon before and after stretching. The bulk balloon before stretching has a middle part of L2 in length, end parts to be bounded to said catheter tube (not shown), and sloped parts S1, S2 between the middle part and the end parts and at both sides of the middle part. The outer diameter of the middle part is larger than that of the end part. Those parts substantially contact firmly to the catheter tube after stretching the balloon and mounting it on the catheter tube (not shown).

The molten solution of the balloon materials contains the-following balloon materials melted at the selected temperature between 150° C. and 25000. The balloon material is selected from the thermoplastic elastomer materials, especially the Styrene-group thermoplastic elastomer materials, including Styrene-Butadiene-Styrene(SBS), Styrene-Polyisoprene-Styrene (S IS), Styrene-Polyethylene/Polybutylene-Styrene (SEBS), and Styrene-PolyethylenelPropylene-Styrene (SEPS) structures. And furthermore, the material having 800% to 1000% tensile rupture ductility is selected from those materials.

According to the present invention, a manufacturing method for the balloon catheter can be provided in which the above described balloon can be formed by dipping a mold having a predetermined diameter a plurality of times into the fused solution or liquid solution containing the material selected from styrene group SBS, SIS, SEBS, SEPS thermoplastic elastomer materials from the viewpoint of flexibility and thrombus.

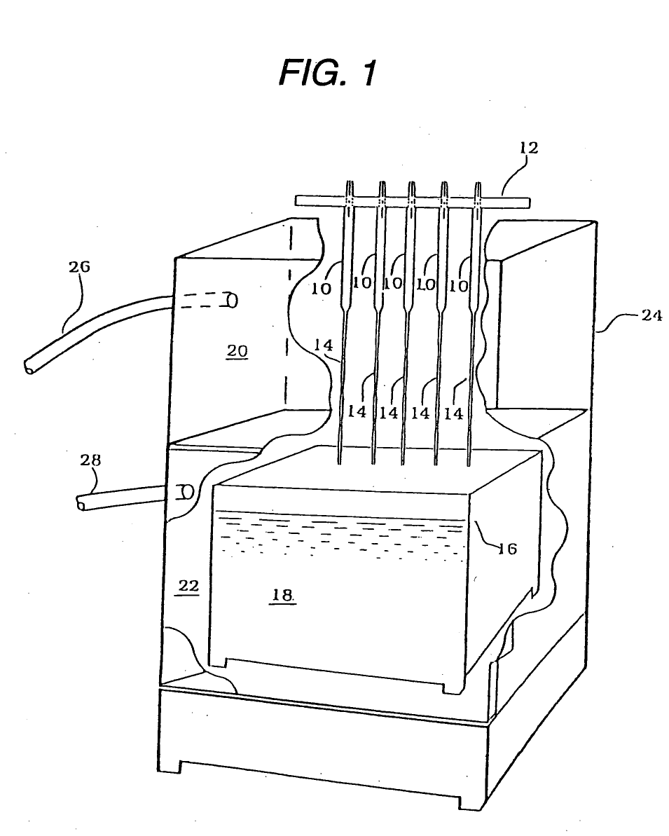

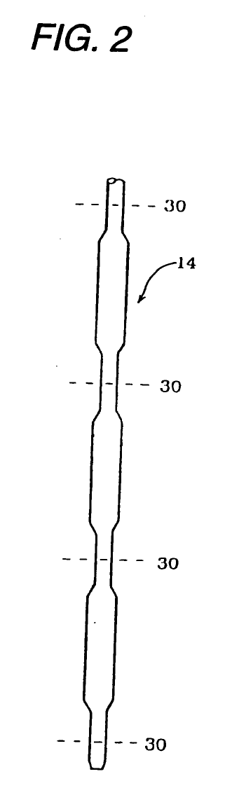

FIG. 1 shows the first embodiment for fabricating the balloon for the balloon catheter according to the present invention. In FIG. 1, the components 10 are a plurality of molds, for example, made of stainless steel, supported by the jig 12. As shown also in FIG. 2, the mold 10 has a balloon formation part 14. The jig 12 is linked to an elevating mechanism (not shown) that moves upward or downward plurality of molds simultaneously. The balloon formation part 14 is dipped into the molten solution 18 of the balloon materials contained in the molten solution bath 16 at the lowest position of the mold. The molten solution bath 16 is contained in the lower compartment 22 of the housing 24 composed of the upper compartment 20 and the lower compartment 22. The components 26 and 28 are tubes or pipes for supplying, for example, nitrogen gas, to the upper and lower compartments, respectively. This gas cools down the balloon materials in the balloon formation part of the elevated mold at the upper compartment 20, and it operates as oxidation inhibitor for the molten solution 18 of the balloon materials contained in the molten solution bath 16 at the lower compartment 22.

The molten solution of the balloon materials contains the following balloon materials melted at the selected temperature between 150° C. and 250° C. The balloon material is selected from the thermoplastic elastomer materials, especially the Styrene-group thermoplastic elastomer materials, including Styrene-Butadiene-Styrene (SBS), Styrene-Polyisoprene Styrene (SIS), Styrene Polyethylene/Polybutylene-Styrene (SEBS), and Styrene Polyethylene/Propylene-Styrene (SEPS) structures. And furthermore, the material having 800% to 1000% tensile rupture ductility is selected from those materials.

Most materials are commercially available. In particular, SBS-group and SEBS-group “elastomer AR” available from Aron Chemical Ltd., SBS-group “JSRTR” from Japan Synthetic Rubber Co. Ltd., 515-group “JSRSIS” from Japan Synthetic Rubber Co. Ltd., 515-group “Bypler” from Kuraray Co., Ltd., SEBS-group “Kraton G” is available from Shell Oil Co., SEBS-group “Ruberon” from Mitsubishi Petrochemical Co., Ltd. and SEPS-group “Scepton” from Kurarayco, Ltd. satisfy the above requirements for the balloon of the catheter of the present invention as well as the balloon made from those materials does not cause thrombus due to its direct contact to the blood in the blood vessel.

The balloon made from the above-described materials is extremely soft itself, and could never damage the inner vascular wall during the movement of the catheter especially in the narrow blood vessel.

In FIG. 1, the balloon formation part 14 of the mold 10 is dipped into the molten material solution 18 for a predetermined period of time and drawn out and its liquid component is evaporated, which is repeated in a predetermined number of times. For example, in a case where the outer diameter of the catheter is 5 and 8 French (FC) (equal to 1.6 mm and 2.7 mm, respectively), the balloons with their thickness being approximately 0.1 mm and 0.14 mm, respectively, are formed, and the balloon with its thickness being 0.31 mm is formed for the outer diameter of the catheter being 12 French (equal to 3.9 mm), which prove acceptable as the balloon for the catheter used for blocking the vascular stream in the anti-cancer drug perfusion system.

FIG. 2 is a magnified view of the balloon formation part 12 of the mold 10. In completing a plurality of repetitive cycles of dipping and evaporation operation, the long balloon material formed on the surface of the balloon forming part is cut off at the position 30 and the individual pieces are extracted separately, and thus plurality of balloon parts are obtained from a single mold 10. In FIG. 2, the balloon part toned has a shape in which the diameter of its center part is slightly larger than the diameter of both of its ends to which the catheter is coupled. This shape is aimed to cope with the diameter expansion, and the shape of the balloon formation part 14 may be a straight cylinder if there is no need for considering the diameter expansion.

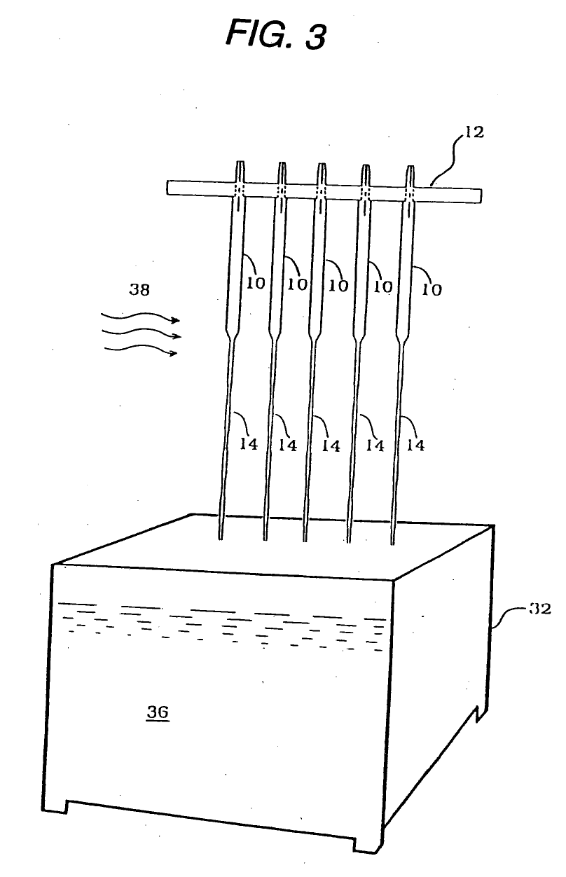

FIG. 3 shows the second embodiment of the balloon fabrication apparatus. As in the embodiment shown in FIG. 1, a plurality of molds 10 having the balloon formation parts 14 are supported by the jig 12 used as a support device so as to enable them to move upward and downward. The balloon formation part 14 is dipped into the liquid bath 36 containing the styrene-group thermoplastic elastomer materials dissolved with organic solvent such as thinner, triol-group, toluene-group and benzene-group, and drawn up to the predetermined uprising position after a predetermined period of time. The balloon formation part is then dried, for example, by hot air 38, and this dipping and evaporation cycle is repeated in a predetermined number of times. The balloon part having the above-described thickness can be obtained by completing these repetitive cycles.

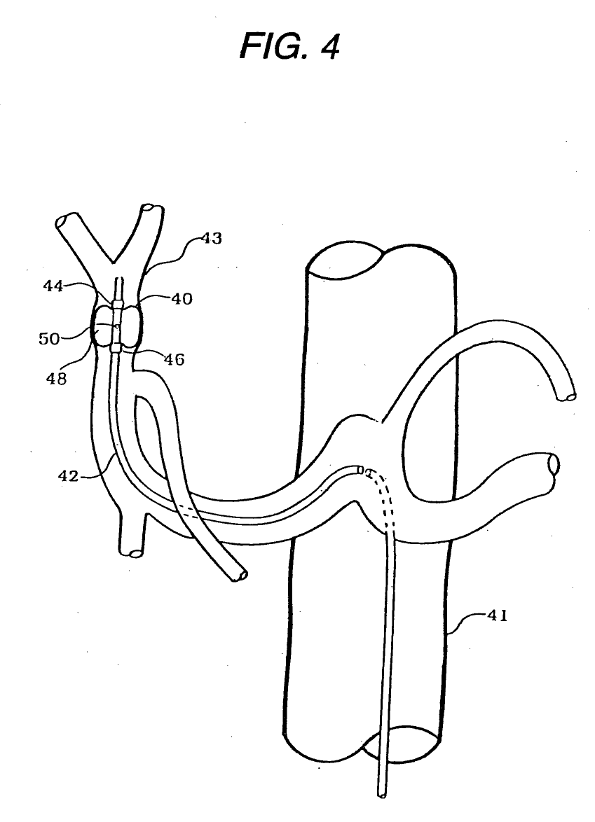

FIG. 4 illustrates the catheter 42 with a balloon 40 at its top end is inserted, for example, from the femoral artery through the aorta 41 to the predetermined position in the hepatic artery 43, where the balloon is expanded for blocking the vascular stream. The balloon 40 is fixed at the periphery of the catheter (catheter tube) 42 by both of its ends 44 and 46, and an expansion cavity 48 is formed when expanded. For this purpose, an expansion fluid aperture 50 is toned for the expansion fluid passage way (not shown) inside and along the catheter. The balloon formed by the above mentioned material with the above mentioned thickness and fixed at the catheter having the above mentioned French index can be expanded up to a diameter approximately 15 times as large as the outer diameter of the catheter. Thus, the balloon is used in a practical application requiring that its outer diameter expand up to approximately several times as large as the outer diameter of the catheter, its expanded outer diameter can return to its initial size.

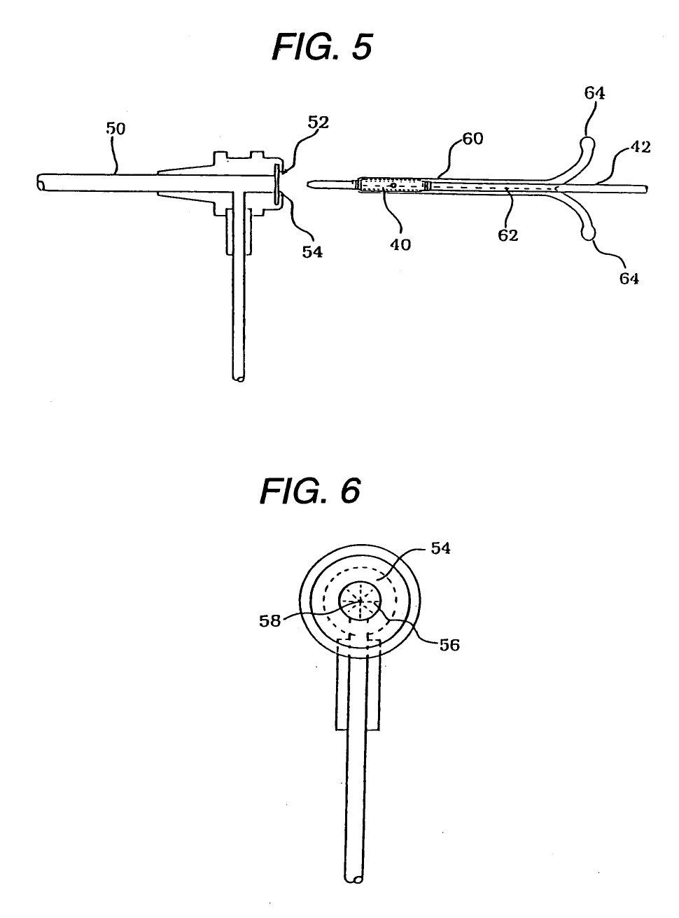

When the catheter is inserted into the blood vessel, in general, a catheter introducer comprising a sheath (external cylinder), an internal cylinder and a guide wire, it necessary, may be inserted initially into the blood vessel, and then the internal cylinder is extracted when the catheter introducer-reaches a predetermined position in the blood vessel. The catheter is then inserted into the sheath, and finally, the catheter is guided by the guide wire and inserted to the specified position in the blood vessel. FIG. 5 illustrates that the catheter 42 is inserted from the insertion part 52 of the sheath 50. As shown also in FIG. 6, the insertion part 52 has a seal film member 54 typically made of rubber materials for preventing the air from penetrating into the sheath. Cut lines 56 are originally formed at the seal film member 54, and by inserting the top edge of the catheter through its center 58, the catheter can be inserted inside the sheath while the sealed condition is maintained. With this configuration, the conventional balloon catheter can be used without any trouble.

However, since a soft and thin material is used in the catheter of the present invention so that the balloon 40 will not damage the inner vascular wall, the balloon 40 may be damaged when the balloon part of the catheter passes through the seal film member. In order to solve this problem, the balloon part of the catheter is covered by the protection tube 60 as shown in FIG. 5 in the present invention. Starting from the state shown in FIG. 5, when the catheter is inserted into the sheath and after the balloon part passes through the seal film member, the protection tube 60 is made to move in the axial direction backwards to a position where it may not interfere with the catheter. The protection tube 60 may also be removed at any position on the catheter (tube) part behind the balloon to which the protection tube 60 is made moved so long as the sealed condition of the film member 54 can be maintained. For the purpose of the latter case mentioned above, members 64 are used for separating the protection tube 60 along the cut line 62 into two pieces for facilitating the separation work. The requirements for the protection tube 60 includes that the air tightness inside the sheath can be guaranteed. The protection tube 60 should not damage the balloon by itself when moving backward in the axial direction relative to the catheter 42.

In order to establish the hermetic seal, the head end of the tube 60 is hermetically contacted to the catheter coupling part of the balloon as shown in FIG. 5. It is required that the hermetic seal condition inside the tube 60 is established by the time the protection tube 60 is moved backwards towards the back end of the catheter 42 in its axial direction and the seal coupling between the catheter 42 and the film member 54 is obtained at the position behind the balloon part of the catheter 42. In order to meet this requirement, a member similar (not shown) to the seal film member 54 can be placed at the back end of the tube 60.

The problem relating to the damage to the balloon by the tube when the tube is moved backwards towards the back end of the catheter can be solved by shaping the top edge of the tube 60 so as to be slightly tapered as shown in the figure, thereby optimizing the size of the aperture at its top edge, and making the inner surface of the aperture smooth. This structure makes it easier for the balloon part of the catheter to insert hermetically into the seal film member.

What is claimed is:

1. A method of manufacturing a balloon catheter which has a balloon for blocking a vascular stream in said blood vessel when inserted in said blood vessel and expanded therein, comprising the steps of:
dipping a mold having a center part and end parts at both sides of the center part into a solution of thermoplastic elastomer material to form a balloon, the diameter of the center part being larger than that of the end part;
drying the balloon formed on the mold;
extracting the balloon dried from the mold; and
mounting the balloon extracted on a catheter tube with the balloon stretched.

2. The method of manufacturing a balloon catheter according to claim 1, wherein said dipping and drying steps are repeated a plurality of times.

3. The method of manufacturing a balloon catheter according to claim 2, wherein the material used for said balloon is selected from one of styrene group SBS, SIS, SEBS, SEPS thermoplastic elastomer materials.

4. The method of manufacturing a balloon catheter according to claim 1, wherein the material used for said balloon is selected from one of styrene group SBS, SIS, SEBS, SEPS thermoplastic elastomer materials.
